(19) United States
(12) Patent Application Publication
(10) Pub. No.: US 2016/0363901 A1
(43) Pub. Date: Dec. 15, 2016

(54) IMAGE FORMING APPARATUS, CONTROL METHOD FOR CURL CORRECTION OF SHEET AND STORAGE MEDIUM

(71) Applicants: KABUSHIKI KAISHA TOSHIBA, Tokyo (JP); TOSHIBA TEC KABUSHIKI KAISHA, Tokyo (JP)

(72) Inventor: Masaya Arakawa, Hiratsuka (JP)

(21) Appl. No.: 14/739,396

(22) Filed: Jun. 15, 2015

(51) Int. Cl. G03G 15/00

(52) U.S. Cl. CPC G03G 15/6576

(57) ABSTRACT

In accordance with an embodiment, an image forming apparatus comprises an image forming section configured to form an image on a sheet; a tray to which the sheet subjected to the image forming processing by the image forming section is discharged; a sensor configured to output a detection signal based on a stacking height of sheets in the tray; and a control section configured to control operations of the image forming section, compare a stacking number of sheets according to a detection signal of the sensor with the actual number of sheets discharged to the tray and carry out a given processing for suppressing a curl of sheet to be subjected to an image forming processing by the image forming section in a case in which a difference between a stacking number of sheets and an actual discharged number of sheets is greater than a preset value.

### FIELD

Embodiments described herein relate generally to a technology in which a curl amount of paper is deduced according to a detection of stacking height and the number of the discharged papers to carry out a control for correcting paper curl.

### BACKGROUND

Conventionally, in an image forming apparatus such as a printer, a copier and the like, especially in an electrophotographic image forming apparatus which forms a toner image on a sheet, various measures have been taken according to a shape of conveyance path, fixing temperature, cooling and the like to reduce paper curl of a paper that is subjected to an image forming processing and is to be discharged.

However, there is such a problem as follows in the conventional paper curl-prevention technology.

In practice, an image quality is greatly affected by an environment such as type of paper, humidity conditioning, temperature, humidity and the like, and it is necessary to reduce a fixing temperature to completely cope with those environmental factors. In this case, there is a risk in the fixation property of image.

### BRIEF DESCRIPTION OF THE DRAWINGS

FIG. 1 is a diagram schematically illustrating the constitution of an image forming apparatus according to an embodiment;

FIG. 2 is a block diagram illustrating the constitution of the image forming apparatus according to the embodiment;

FIG. 3 is a flowchart illustrating a processing accompanying a full detection in a printing processing;

FIG. 4 is a diagram illustrating an example of a setting screen for setting a threshold value rate;

FIG. 5 is a diagram illustrating an example of a setting screen for setting the number of threshold value;

FIG. 6 is a diagram illustrating an example of a screen in which that a processing for curl suppression is being executed is displayed;

FIG. 7 is a diagram illustrating an example of a screen in which processing content for curl suppression is preset; and

FIG. 8 is a flowchart illustrating a processing of a second embodiment.

### DETAILED DESCRIPTION

In accordance with an embodiment, an image forming apparatus comprises an image forming section configured to form an image on a sheet; a tray to which the sheet subjected to the image forming processing by the image forming section is discharged; a sensor configured to output a detection signal based on a stacking height of sheets in the tray; and a control section, wherein the control section compares the stacking number of sheets according to a detection signal of the sensor with the actual number of sheets discharged to the tray and carries out a given processing that contributes to curl suppression of a sheet to be subjected to an image forming processing by the image forming section in a case in which a difference between a stacking number of sheets and an actual discharged number of sheets is large, that is, in a case in which a difference between the stacking number of sheets and the actual discharged number of sheets is greater than a preset value.

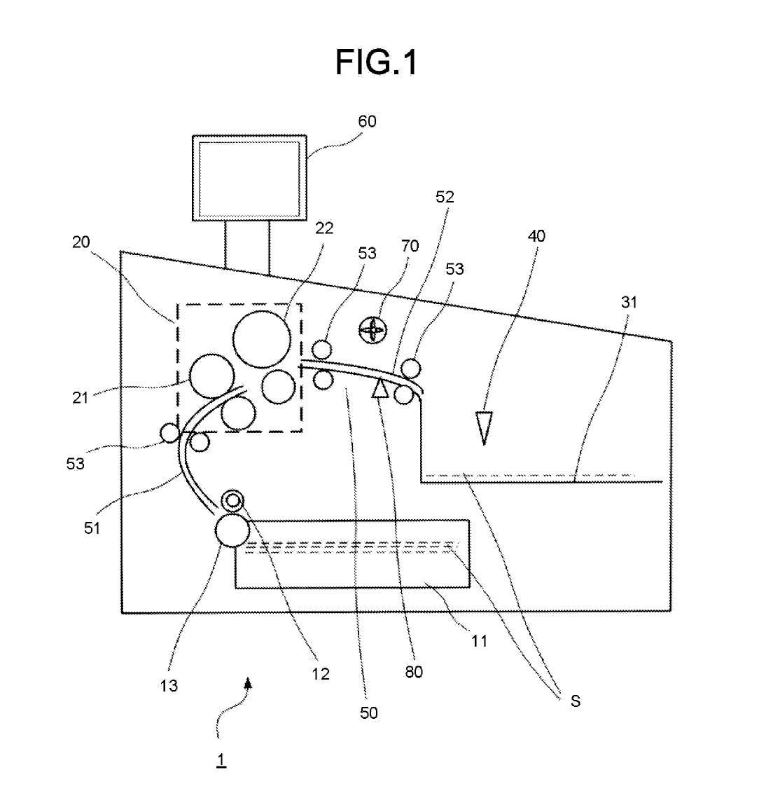

Hereinafter, the present embodiment is described more specifically with reference to the accompanying drawings. FIG. 1 is a schematic diagram illustrating the constitution of an image forming apparatus according to the embodiment.

As shown in FIG. 1, an image forming apparatus 1 comprises an image forming section 20 which forms an image on a sheet, a sheet discharge tray 31 to which the sheet subjected to the image forming processing by the image forming section 20 is discharged, a sensor 40 which outputs a detection signal based on a stacking height of sheets in the sheet discharge tray 31 and a later-described control section (CPU 2) which controls operations of the image forming section 20. The image forming apparatus 1 further comprises a housing tray 11 in which sheets to be supplied to the image forming section 20 are housed and a sheet conveyance path 50 configured to convey a sheet to be subjected to an image forming processing (printing/print processing) from the housing tray 11 to the sheet discharge tray 31 via the image forming section 20.

The housing tray 11 and the sheet discharge tray are cassette-shaped members for housing and discharging sheets of various kinds of sizes, respectively. Herein, for facilitating the description, it is exemplified that the housing tray 11 and the sheet discharge tray 31 respectively house and discharge a normal A4-sized sheet S, and the housing tray 11 and the sheet discharge tray 31 can also respectively house and discharge a sheet of other sizes such as A3, B4 and the like. Further, the number of the housing tray 11 and the number of the sheet discharge tray 31 may respectively be set to more than one.

A feed roller 12 and a separation roller 13 are arranged in the housing tray 11 to separate the sheet S one by one from a sheet bundle housed and stacked in the housing section 11 and feeds it to the sheet conveyance path 50.

On the other hand, a sensor 40 is arranged in the sheet discharge tray 31 for detecting that the sheets S subjected to an image forming processing by the image forming section 20 are discharged or stacked, and a stacking height of the sheets S. Herein, a full detection sensor for outputting a full detection signal in a case in which a height of the stacked sheets S reaches a given height (housing limit) is arranged as the sensor 40.

In the present embodiment, the full detection sensor 40 has a mechanical constitution that it moves positions in the sheet discharge tray 31 according to the stacking height of the sheets S and it outputs a full detection signal when reaching a given position. Furthermore, the full detection sensor 40 can also be an optical sensor which optically detects the stacking height of the sheets S in the sheet discharge tray 31, and outputs a full detection signal when the stacking height of sheet reaches a given position.

In the present embodiment, the image forming section 20 of electrophotographic type which forms a toner image on a sheet comprises a transfer roller 21 for enabling a toner image (electrostatic latent image) to adhere to the sheet and a fixing roller 22 for heating the adhered electrostatic latent image to fix it.

Herein, for facilitating the description, it is exemplified that the image forming section 20 has a monochrome printing constitution in which a monochrome color (black) toner is used, and the image forming section 20 may have a full color printing constitution in which multiple colors (for example, four colors of cyan, magenta, yellow and black) toner are used.

The sheet conveyance path 50 roughly comprises a conveyance path from the housing tray 11 to the image forming section 20 (hereinafter referred to as an “upstream side conveyance path”) and a conveyance path from the image forming section 20 to the sheet discharge tray 31 (hereinafter referred to as a “downstream side conveyance path”). As other embodiment, in a case in which a plurality of housing trays 11 is arranged, an upstream side conveyance path 51 is a path connected from a mergence point at which paths from each of the housing trays (11a, 11b . . . ) are merged into one path to the image forming section 20. Similarly, in a case in which a plurality of sheet discharge trays 31 is arranged, a downstream side conveyance path 52 becomes a plurality of paths connected from the image forming section 20 at which the path at the downstream side (sheet advancing direction side) is bifurcated into a plurality of paths to each of the sheet discharge trays 31 (31a, 31b . . . ).

No matter which constitution the sheet conveyance path 50 is set to have, conveyance rollers 53 are arranged in the sheet conveyance path 50 at given intervals such that the sheet S housed in the housing tray 11 is conveyed smoothly to the sheet discharge tray 31 via the image forming section 20.

Further, in the downstream side conveyance path 52 or near the downstream side conveyance path 52, a cooling fan 70 is arranged to cool a sheet of which the temperature is increased through heat-fixing of a heat source such as a heater (not shown) inside the fixing roller 22. A sheet passing sensor 80 is further arranged in the downstream side conveyance path 52 for detecting the passing of a sheet printed by the image forming section 20.

A plurality of sheets subjected to an image forming processing by the image forming section 20 is sequentially discharged to the sheet discharge tray 31 and stacked in the sheet discharge tray 31. Thus, with the increase of the number of stacked sheets in the sheet discharge tray 31, a full detection signal is likely to be outputted from the full detection sensor 40.

The image forming apparatus 1 is equipped with a display 60 functioning as a display section and an operation input section. The display 60 which is, for example, a so-called touch panel type liquid crystal display device displays various state of the image forming apparatus 1 and receives various input operations of a user.

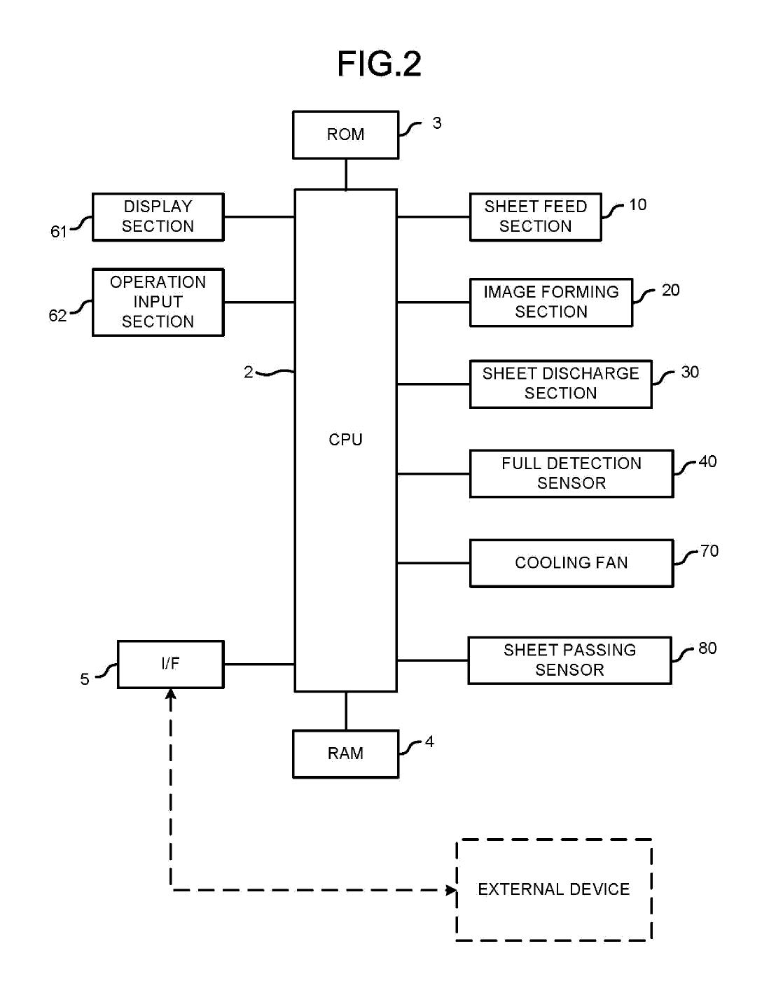

FIG. 2 is a block diagram illustrating a main function and an electrical constitution of the image forming apparatus. As shown in FIG. 2, the image forming apparatus 1 includes a CPU 2 serving as a control section for controlling the entire apparatus, an ROM 3 and an RAM 4 in which programs executed by the CPU 2 and various data including a later-described setting data are stored, and an interface (I/F) 5 for communicating with an external device. The image forming apparatus 1 further comprises a sheet feed section 10 for carrying out conveyance of sheets to be sent to the image forming section 20, and a sheet discharge section 30 for discharging sheets subjected to image forming processing by the image forming section 20 to the sheet discharge tray 31. Moreover, the image forming apparatus 1 includes the above-described full detection sensor 40, the cooling fan 70, the sheet passing sensor 80, a display section 61 functioning as the display 60 and an operation input section 62.

In order to send the sheets S in the housing tray 11 to the image forming section 20, the sheet feed section 10 is equipped with a motor (not shown) for driving the sheet feed roller 12, the separation roller 13 and the conveyance rollers 53 in the upstream side conveyance path 51 which are described above. Similarly, in order to discharge sheets subjected to image forming processing by the image forming section 20 to the sheet discharge tray 31, the sheet discharge section 30 includes a motor (not shown) for driving the conveyance rollers 53 in the downstream side conveyance path 52.

The I/F 5 communicates with various external devices such as a user PC, a network server and the like, and provides various kinds of input data including a printing data sent from the external devices to the CPU 2, the image forming section 20 and the like. The I/F 5 further provides various data outputted from the CPU 2 to the external devices.

The image forming section 20 forms an image on a sheet. Specifically, the image forming section 20 performs a given processing on a printing data to be sent from the external devices to generate image data under the control of the CPU 2. Next, the image forming section 20 forms a toner image (electrostatic latent image) based on the image data on a sheet with the transfer roller 21, and heats the formed toner image to fix it to the sheet through the fixing roller 22.

The display section 61 carries out a display of a state of apparatus, a display of a setting screen by the user, and a display of a warn to the user and a reminder through a display screen of the display 60 mainly and through issuing a sound such as an alarm sound in some cases under the control of the CPU 2. The user presses (touches) various kinds of software keys displayed in the display 60, in this way, the operation input section 62 outputs data corresponding to the touched keys to the CPU 2.

The CPU 2 reads various programs and data stored in the ROM 3 and the RAM 4 to execute them, and outputs control signals to the sheet feed section 10, the image forming section 20, the sheet discharge section 30, the cooling fan 70, the display section 61 and the like during the execution of a printing processing to control the sections described above. The CPU 2 further carries out various processing described later based on the input data of the operation input section 62, the input data from an external device communicated through the I/F 5, the detection signals of the full detection sensor 40 and the sheet passing sensor 80 and the like.

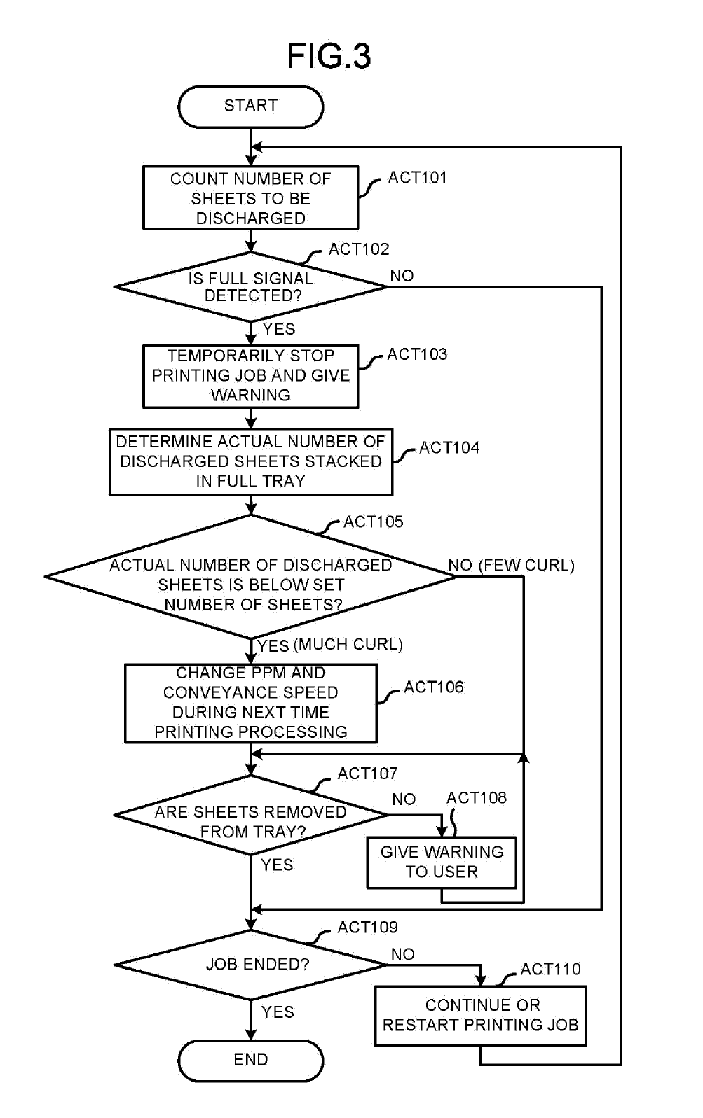

FIG. 3 is a flowchart illustrating a control processing accompanying a full detection in the printing processing of one job of the image forming apparatus 1. Thus, the control of the image forming section 20 during the printing processing is carried out separately from the flowchart shown in FIG. 3. Further, FIG. 3 is a flowchart relating to one sheet discharge tray 31 equipped with the full detection sensor 40, and the control processing in FIG. 3 can be carried out for each of the sheet discharge trays equipped with the full detection sensor in a case in which the image forming apparatus comprises a plurality of sheet discharge trays 31 (31a, 31b . . . ).

When a printing processing in the image forming apparatus 1 is started based on, for example, a print execution demand and a transmission of printing data from a PC operated by the user, the CPU 2 counts the number of sheets that are to be printed in the printing processing and to be discharged to a corresponding sheet discharge tray 31 (ACT 101). The count processing can be carried out more correctly by monitoring the output of the sheet passing sensor 80 that is arranged, for example, at the downstream side of the image forming section 20 and at the upstream side of the corresponding sheet discharge tray.

During the printing processing, the CPU 2 determines whether or not there is a full detection based on the output of the full detection sensor 40 of the corresponding sheet discharge tray 31 (ACT 102). That is, the CPU 2 determines whether or not the sheet discharge tray 31 (discharge destination) becomes full with the sheets discharged in the printing processing by monitoring output signals from the full detection sensor 40 of the sheet discharge tray 31 serving as the discharge destination.

In addition to the determination on full detection, the CPU 2 further carries out a determination on whether or not a printing job is ended (ACT 109). During a period the printing job has not been ended yet (NO in ACT 109), the printing job is continued and the routine from ACT 101 is carried out repeatedly (ACT 110-ACT 101).

Herein, in a case in which the printing job is ended while the full is not detected (NO in ACT 102 and YES in ACT 109), the CPU 2 terminates the series of routines shown in FIG. 3.

On the other hand, in a case in which it is determined that there is a full detection in the printing processing (YES in ACT 102), the CPU 2 temporarily stops (interrupts) the printing job and carries out a warning processing to inform the user that the sheet discharge tray 31 is full (ACT 103). Such a warning processing may be carried out by, for example, outputting an alarm sound with the display section 61, or displaying and outputting a message such as “please remove the sheets because the sheet discharge tray is full” in the display section 61 or in the PC of the user.

The CPU 2 further determines the number of sheets counted from the start to the interruption of the printing processing, that is, the actual number of sheets discharged to the sheet discharge tray 31 which is full (ACT 104).

Next, the CPU 2 determines whether or not the determined number of discharged sheets is less than a given number of sheets set as a “threshold value” for the sheet discharge tray (ACT 105). According to the determination result, in a case in which the number of discharged sheets is less than the given number of sheets (YES in ACT 105), the CPU 2 deems that the curl amount of sheet is large and proceeds to the processing in ACT 106. On the contrary, in a case in which the number of discharged sheets is greater than the given number of sheets (NO in ACT 105), the CPU 2 deems that the curl amount of sheet is small, and proceeds to the processing in ACT 107 directly without carrying out the processing in ACT 106.

Herein, the “threshold value” is a value to some degree smaller than the number of stackable sheets (limit value) having no curl in the sheet discharge tray 31. For example, in a sheet discharge tray of which the number of stackable sheets (limit value) is 500, it is considered to set the number of threshold value to 300. That is, in a case in which a full signal is detected when less than 300 sheets are stacked in the sheet discharge tray 31 that can stack 500 sheets having no curl, it is deemed that the condition of curl generated in the sheets exceeds the allowable range. On the contrary, in a case in which a full signal is detected when more than 301 sheets are stacked in the sheet discharge tray 31, it is deemed that the condition of curl generated in the sheets is within the allowable range.

In the present embodiment, an initial value of the number of “threshold value” is set by integrating a given rate on the number of stackable sheets in the sheet discharge tray 31. The initial value can be changed through a setting operation of a manager or the user. For example, in the example described above, it is assumed that the number of the threshold value is set to 300 as the initial value by integrating a rate of 3/5 on the number of stacked sheets (limit value) in the sheet discharge tray. Alternatively, through a setting operation of a manager or the user, it is possible to change the rate to 4/5 to set the number of threshold value to 400, or change the rate to 2/5 to set the number of threshold value to 200.

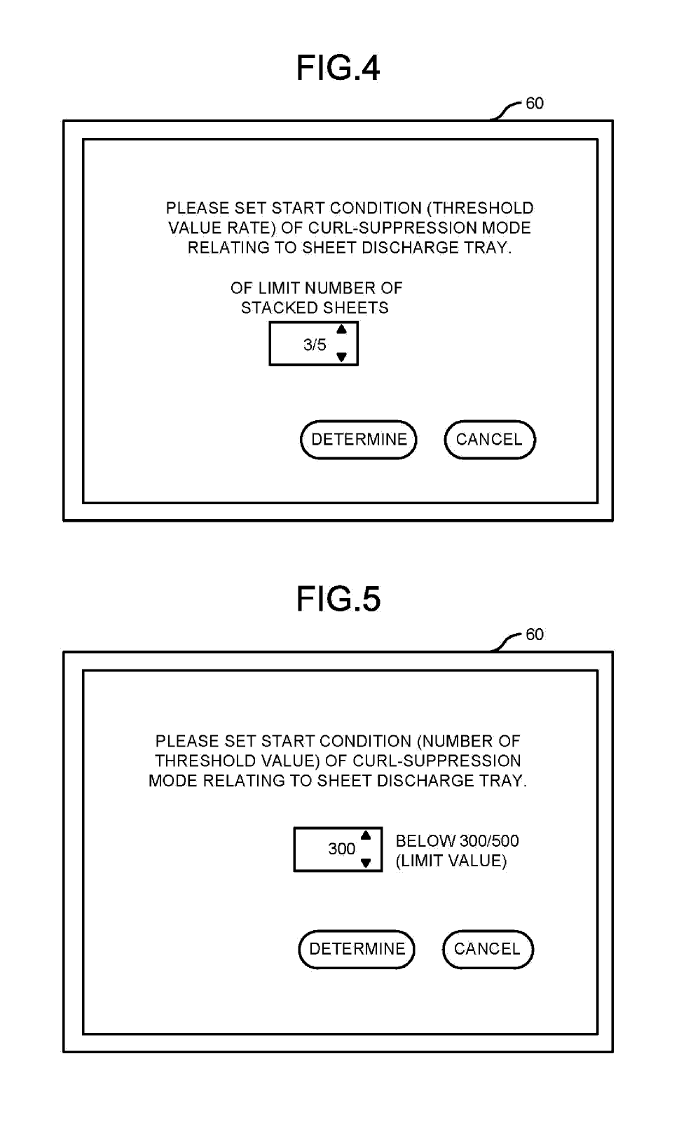

An example of a setting screen for setting the threshold value described above is shown in FIG. 4 and FIG. 5, respectively. Herein, FIG. 4 is a setting screen for setting a rate of the threshold value, and FIG. 5 is a setting screen for setting the number of threshold value. It is exemplified that the setting screens in FIG. 4 and FIG. 5 are displayed in the display 60 of the image forming apparatus 1, and the setting screens may be displayed in a display section of an external device such as a PC of the user. The contents set in the setting screens are stored in the RAM 4 and read by the CPU 2.

In the setting screen in FIG. 4, the rate (3/5) serving as the initial value can be changed within a range of 1/5˜5/5 by moving arrow symbols in the setting screen up and down through an operation of the operation input section 62. Similarly, in the setting screen in FIG. 5, the numeric value of (less than) 300 serving as the initial value can be changed within a range of 50˜500 taking 50 as a unit. As a modification of the setting screen in FIG. 5, it can be set that the number of threshold value can be input randomly within a range in which it is not greater than the number of stackable sheets (limit value) in the sheet discharge tray.

In ACT 106, the CPU 2 carries out a processing for suppressing a thermal deformation of a sheet to be subjected to an image forming processing by the image forming section 20. In the present embodiment, the CPU 2 rewrites the data in the RAM 4 to change set values of a number of printings per unit time and a conveyance speed in a next time printing processing. More specifically, the CPU 2 changes the set value of the conveyance speed of the conveyance rollers 53 at the image forming section 20 and the downstream side conveyance path 52 (that is, the set data in the RAM 4) such that a PPM (print per minute) serving as the number of printings per unit time in the next time printing processing and the conveyance speed of the printed sheet become a smaller and slower value than those at the present time, respectively. As one example, in a case in which a general printing processing is carried out at 50 PPM, the number of printings per unit time of the image forming section 20 is set to half of 50 PPM (25 PPM) in a next time printing processing and the conveyance speed of the conveyance rollers 53 at the downstream side conveyance path 52 is also set to half. At this time, the conveyance speed of the conveyance rollers 53 at the upstream side conveyance path 51 can be randomly set, and it may also be set to a same value as that of the conveyance rollers 53 at the downstream side conveyance path 52.

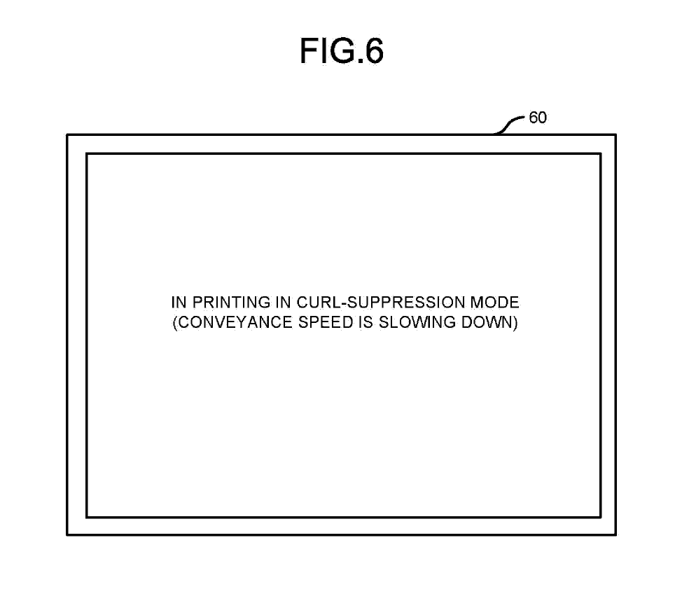

By performing settings as stated above, during the next time printing processing, the CPU 2 reads the set data in the RAM 4 to control the motors of the image forming section 20 and the conveyance rollers 53 to slow down the conveyance speed of the sheet S at the image forming section 20 and at the downstream side of the image forming section 20. Thus, during the period the sheet S subjected to an image forming processing by the image forming section 20 is conveyed on the downstream side conveyance path 52, the time cooled by the cooling fan 70 becomes relatively long, and thus the curl amount of sheet can be reduced when it is discharged to the sheet discharge tray 31. Such a printing operation is referred to as a “curl-suppression mode”, the user may feel reassurance by displaying a message “In printing in curl-suppression mode” and the operation (control) content of the message on the display 60 (display section 61) of the image forming apparatus 1 as shown in FIG. 6. The display can also be carried out on a display section of the PC of the user.

Herein, “in the next time printing processing” refers to “printing operations after the printing job is restarted” in the present embodiment. That is, in the present embodiment, in the printing processing after the printing job is interrupted through a full detection, the sheets are removed from the sheet discharge tray 31 and then the printing job is restarted, the printing amount and the number of discharged sheets at per unit time are relatively reduced. Thus, even after the printing job in the same job is restarted (ACT 110), it is also possible to suppress the curl amount of sheet.

On the other hand, through a setting operation of the manager or the user, the setting on “next,time” can be changed from “printing operations after the printing job is restarted” to “printing operations from a next job”. Such a setting is effective during a same job in a case of desiring to keep the printing speed as fast as possible, or in a case of desiring to make the curl amount of sheet substantially identical to each other before and after the interruption of job.

In ACT 107, the CPU 2 determines whether or not sheets are removed from the sheet discharge tray 31. The determination can be carried out by monitoring the output of the full detection sensor 40. In a case in which there is other sensor (not shown) for detecting whether or not there is a sheet in the sheet discharge tray 31, the determination in ACT 107 may be carried out by monitoring the output of the other sensor.

During a period the sheets have not been removed from the sheet discharge tray 31 (NO in ACT 107), the CPU 2 displays a message “the sheets should be removed from the tray” in the display section 61 or the PC of the user to give a warning to the user (ACT 108).

If it is determined that the sheets are removed from the sheet discharge tray 31 (YES in ACT 107), the CPU 2 determines whether or not the printing job is ended (ACT 109). In a case in which the printing job is not ended, the CPU 2 restarts the printing job (ACT 110), and repeats the processing from ACT 101 described above. If the printing job is ended, the CPU 2 terminates the series of processing described above.

In this way, according to the image forming apparatus 1 of the present embodiment, an occurrence of curl due to the heat of sheet can be suppressed quickly by carrying out printing processing for the sheets in the “curl-suppression mode” described above. Thus, it is also possible to reduce a risk that a trouble such as a jam due to excessive sheet curl generates according to the image forming apparatus 1.

In the embodiment described above, a processing for reducing the number of printings of sheets per unit time and a processing for slowing down the conveyance speed of sheets are set to be the control processing of “curl-suppression mode” for suppressing the curl (ACT 106 and ACT 110). However, the present invention is not limited to this, and it is possible to add or substitute various processing that contribute to the curl-suppression due to the thermal deformation. As other control processing for suppressing the curl by the CPU 2, for example, a processing for increasing the output (rotary speed) of the cooling fan 70, a processing for setting a low fixing temperature of the fixing roller 22 (fixing device) and the like can be listed. In a case of setting a low fixing temperature, a other processing that contributes to the curl suppression may be carried out together, and thus it is possible not to lower the fixing temperature compared to the conventional fixing temperature, which reduces the risk of the fixing property.

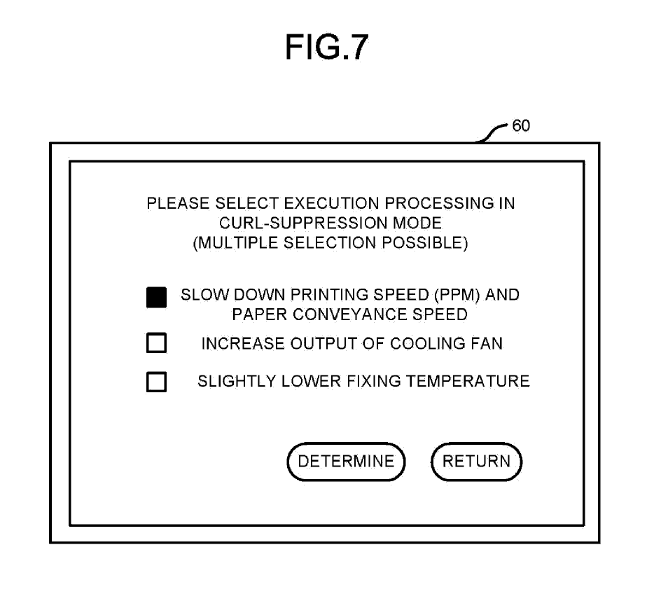

FIG. 7 is an example of a setting screen in which the content of a control processing for suppressing the curl (an execution processing in the curl-suppression mode) is set to be selectable by the user. It is exemplified that the setting screen in FIG. 7 is displayed in the display 60 (display section 61) of the image forming apparatus 1, and it can also be displayed in a display section of an external device such as a PC of the user and the like. The setting screen in FIG. 7 is a screen displayed after the setting in the setting screen in FIG. 4 or FIG. 5 described above (that is, after selecting a “determine” button). However, the order of setting screens to be displayed may be opposite to the order described in the embodiment described above. Further, the setting content in FIG. 4 or FIG. 5 and the setting content in FIG. 7 can be displayed in one screen. The contents set in the one setting screen (set data) is to be stored in the RAM 4 and to be read by the CPU 2 at the time of the execution processing in the curl-suppression mode.

### A Second Embodiment

In the embodiment described above, in a case in which the full signal of sheets in the sheet discharge tray 31 is detected by the full detection sensor 40, it is set to the constitution that the given processing described above is performed after the printing job is temporarily stopped (interrupted) and the sheets are removed from the sheet discharge tray 31. However, it may be set to a constitution that the printing job is temporarily stopped (interrupted) before the sheets in the sheet discharge tray 31 become full, or a constitution that the given processing described above is performed without temporarily stopping (interrupting) the printing job. Such a constitution may be realized by, for example, changing a setting on a stacking height when the full detection sensor 40 detects a full signal. Alternatively, it can be realized by arranging other sensor that can detect the stacking height of the sheets S in the sheet discharge tray 31.

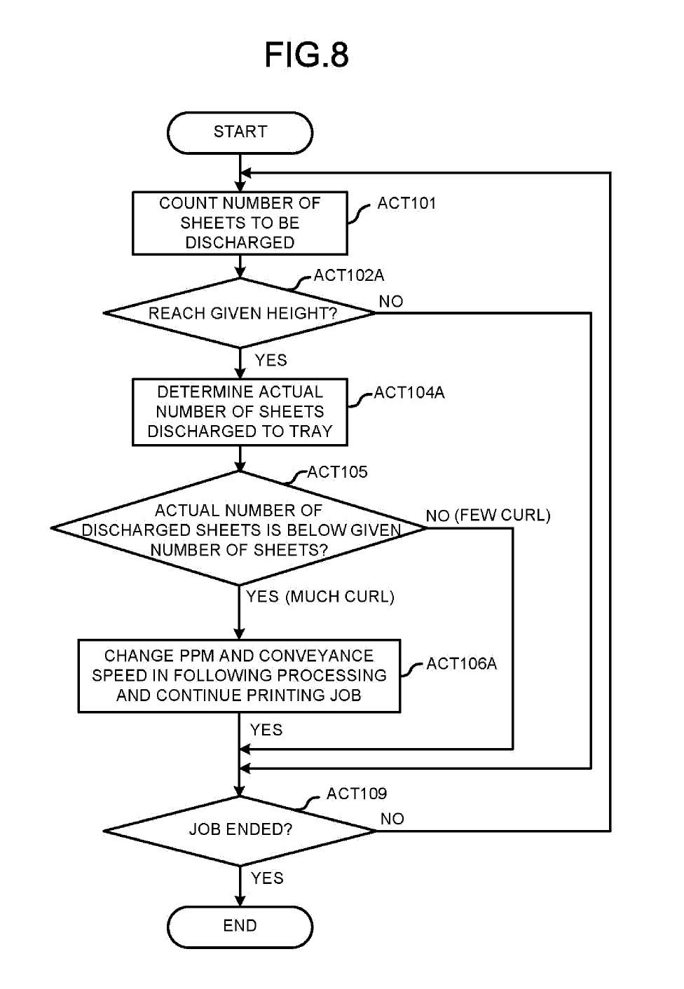

In addition to the full detection sensor 40, other sensor (not shown) that can detect the stacking height of the sheets S (hereinafter referred to as a “second sensor”) is arranged in the sheet discharge tray 31. FIG. 8 is a flowchart in a case of carrying out a processing that contributes to the curl suppression using the second sensor. A control processing shown in FIG. 8 can be performed separately from the control processing shown in FIG. 3 using the full detection sensor 40. On the other hand, the processing that is same as or similar to the flowchart in FIG. 3 is applied with the same or similar ACT reference numeral. In the description in FIG. 8, the description of the processing the same as the processing shown in FIG. 3 is properly omitted.

In the flowchart in FIG. 8, in a printing processing, the CPU 2 determines whether or not a stacking height of the sheets S in the sheet discharge tray 31 reaches a given height based on an output signal of the second sensor (ACT 102A). That is, the CPU 2 determines whether or not the stacking height of the sheets that are printed in the printing processing and discharged to the sheet discharge tray 31 reaches the given height by monitoring the output signal from the second sensor of the sheet discharge tray 31.

Herein, the “given height” is set to an arbitrary height position below a position where the full detection sensor 40 detects a full signal. By performing such a setting, it is possible to carry out various processing for suppressing thermal deformation of sheet even in a case in which the printing job isn't temporarily stopped (interrupted) and the number of printings is relatively small.

In a case in which it is determined that the stacking height reaches the given height (YES in ACT 102A), the CPU 2 determines the number of sheets counted from the start of the printing processing to a moment when it is determined that the stacking height reaches the given height, that is, the actual number of sheets (discharged to the sheet discharge tray 31) of which the stacking height reaches the given height (ACT 104A).

Next, the CPU 2 determines whether or not the determined number of discharged sheets is less than a given number of sheets set as a “threshold value” for the sheet discharge tray 31 (ACT 105). According to the determination result, in a case in which the number of discharged sheets is less than the given number of sheets (YES in ACT 105), the CPU 2 deems that the curl amount of sheet is large and proceeds to the processing in ACT 106. On the contrary, in a case in which the number of discharged sheets is greater than the given number of sheets (NO in ACT 105), the CPU 2 deems that the curl amount of sheet is small, and proceeds to the processing in ACT 109 directly without carrying out the processing in ACT 106A.

Further, the processing in ACT 105 is the same as the flowchart in FIG. 3, and the “threshold value” mentioned herein is a value to some degree smaller than the number of sheets in a case in which the sheets having no curl are stacked in the sheet discharge tray 31 until its stacking height reaches the “given height position (ACT 102A)”.

For example, the example stated above, that is, may be considered to be a case in which the number of threshold value detected by the full detection sensor 40 is set to 300 in a sheet discharge tray of which the number of stackable sheets (limit value) is 500. In this case, it is exemplified that the number of sheets corresponding to the “given height position (ACT 102A)” detected by the second sensor is 50 and the number of threshold value detected by the second sensor is 30. The setting method of the “threshold value” and the like are similar to the method described above.

In this example, in a case in which a height position where 50 sheets having no curl should be stacked is detected by the second sensor and the actual number of stacked sheets in the sheet discharge tray is less than 30, it is deemed that the condition of curl generated in the sheets exceeds an allowable range. On the other hand, in a case in which the “given height position (ACT 102A)” is detected in a state in which more than 30 sheets are stacked in the sheet discharge tray 31, it is deemed that the condition of curl generated in the sheets is within the allowable range.

In ACT 106A, the CPU 2 carries out a control processing of (curl-suppression mode) for suppressing a thermal deformation of a sheet to be subjected to an image forming processing by the image forming section 20. The detailed processing content is the same as the processing (ACT 106) in FIG. 3, and the processing described above is carried out directly without temporarily stopping (interrupting) the printing job. For example, the CPU 2 controls the conveyance speed of the conveyance rollers 53 at the image forming section 20 and the downstream side conveyance path 52 in real time such that a PPM (print per minute) and the conveyance speed of the printed sheet become a smaller and slower value than those at the present time, respectively.

In this case, the motors of the image forming section 20 and the conveyance roller 53 are controlled by the CPU 2 such that the conveyance speed of the sheet S at the image forming section 20 and at the downstream side of the image forming section 20 slows down while the printing job is continued. Thus, as long as the sheet discharge tray 31 is not full with the sheets, the user doesn't need to remove the sheets from the sheet discharge tray 31.

However, similar to the flowchart in FIG. 3, it can also be set to a constitution in the second embodiment such that a processing such as temporarily stopping (interrupting) the printing job described above (ACT 103) is carried out.

In the embodiments described above, it is exemplified that the image forming apparatus is an electrophotographic printer. However, it is not limited to this, and various image forming apparatuses comprising an image forming section which may generates a curl on a sheet subjected to an image forming processing can be applicable. The image forming apparatus is not limited to a printer, and a facsimile apparatus, a copier, or a multi-functional peripheral of a combination of the facsimile apparatus and a copier can also be applicable.

While certain embodiments have been described, these embodiments have been presented byway of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
an image forming section configured to form an image on a sheet, the image forming section includes a transfer section which transfers a toner image to the sheet and a fixing section which heats the transferred toner image to fix it;
a tray to which the sheet subjected to the image forming processing by the image forming section is discharged;
a first sensor configured to output a detection signal based on a stacking height of sheets in the tray;
a second sensor configured to detect a height position of stacked sheets before the tray is filled with the sheets;
a fan configured to cool the sheet which the fixing section heats and is conveyed to the tray; and
a control section configured to compare a stacking number of sheets according to a detection signal of the first sensor with the actual number of sheets discharged to the tray and carry out a given processing for suppressing a curl of sheet to be subjected to an image forming processing by the image forming section in a case in which a difference between a stacking number of sheets and an actual discharged number of sheets is greater than a preset value, wherein the control section is further configured to compare the height position of the stacked sheets with the actual number of sheets discharged to the tray and carry out the given processing for suppressing the curl of the sheet to be subjected to the image forming processing in a case in which a difference between the height position of the stacked sheets and the actual discharged number of sheets is greater than the preset value, and
wherein the given processing is a processing for slowing down a conveyance speed of the sheet to be subjected to an image forming processing by the image forming section and cooling the sheet, by use of the fan, which the fixing section heats and is conveyed to the tray.

2. (canceled)

3. The image forming apparatus according to claim 1, wherein
the given processing is a processing for lowering a fixing temperature of the fixing section.

4. The image forming apparatus according to claim 1, wherein
the first sensor is a full detection sensor for outputting a full detection signal when the tray is full of the sheets subjected to the image forming processing; and
the control section determines, when the full detection sensor outputs a full detection signal, whether or not an actual number of sheets discharged to the tray is less than a given number of sheets, and carries out the given processing in a case in which it is less than the given number of sheets.

5. The image forming apparatus according to claim 4, further comprising:
a display section configured to display a message indicating that the given processing has been carried out.

6. A control method for curl correction of a sheet, including:
transferring a toner image to a sheet;
heating the transferred toner image to fix it;
comparing a stacking number of sheets in a tray according to a detection signal with an actual discharged number of sheets;
comparing a height position of stacked sheets in the tray with the actual number of sheets discharged to the tray;
carrying out a given processing for suppressing a curl of the sheet to be subjected to an image forming processing in a case in which a difference between the stacking number of sheets and the actual discharged number of sheets is greater than a preset value; and
carrying out the given processing for suppressing the curl of the sheet to be subjected to the image forming processing in a case in which a difference between the height position of the stacked sheets and the actual discharged number of sheets is greater than the preset value,
where in the given processing is a processing for slowing down a conveyance speed of the sheet to be subjected to an image forming processing and cooling the sheet which is heated to fix the transferred toner image on the sheet and is conveyed to the tray.

7. (canceled)

8. The method according to claim 6, wherein
the given processing is a processing for lowering a fixing temperature to fix the transferred toner image on the sheet.

9. A non-transitory computer storage medium capable of being read by a control section stores programs to be executed by the control section of an image forming apparatus comprising an image forming section configured to form an image on a sheet, the image forming section includes a transfer section which transfers a toner image to the sheet and a fixing section which heats the transferred toner image to fix it, a tray to which the sheet subjected to the image forming processing by the image forming section is discharged, a first sensor configured to output a detection signal based on a stacking height of sheets in the tray, a second sensor configured to detect a height position of stacked sheets before the tray is filled with the sheets, a fan configured to cool a sheet which the fixing section heats and is conveyed to the tray, and a control section configured to control operations of the image forming section, storing:
a program for comparing a stacking number of sheets according to a detection signal of the first sensor with an actual number of sheets discharged to the tray, carrying out a given processing for suppressing a curl of sheet to be subjected to an image forming processing by the image forming section in a case in which a difference between the stacking number of sheets and the actual discharged number of sheets is greater than a preset value, comparing the height position of the stacked sheets with the actual number of sheets discharged to the tray and carrying out the given processing for suppressing the curl of the sheet to be subjected to the image forming processing in a case in which a difference between the height position of the stacked sheets and the actual discharged number of sheets is greater than the preset value, wherein the given processing is a processing for slowing down a conveyance speed of the sheet to be subjected to an image forming processing by the image forming section and cooling the sheet, by using the fan, which the fixing section heats and is conveyed to the tray.

10. (canceled)
